(19) United States
(12) Patent Application Publication
(10) Pub. No.: US 2024/0153277 A1
(43) Pub. Date: May 9, 2024

(54) METHOD AND DEVICE FOR DETERMINING A NUMBER OF PERSONS IN A MOVING VEHICLE

(71) Applicant: Yunex Traffic Austria GmbH, Vienna (AT)

(72) Inventors: Christoph WONDRACEK, Hollabrunn (AT); Christian PERSCHL, Hautzendorf (AT); Bernd KUBU, Gloggnitz / Heufeld (AT)

(21) Appl. No.: 18/503,910

(22) Filed: Nov. 7, 2023

(30) Foreign Application Priority Data
Nov. 7, 2022 (EP) 22205863.8

(51) Int. Cl. G06V 20/54; G06V 10/14; G06V 10/77; G06V 20/40; G06V 40/10

(52) U.S. Cl. CPC G06V 20/54; G06V 10/14; G06V 10/77; G06V 20/40; G06V 40/10; G06V 10/82

(57) ABSTRACT

Certain aspects relate to a device and a method for determining a number of persons in a travelling vehicle, wherein multiple images of a recording area are taken in chronological succession by a camera and the images are stored in a data memory, wherein an arrival point in time of the travelling vehicle in the recording area is determined, wherein at least one image, which was recorded in a time range around the arrival point in time, is selected from the data memory on the basis of the arrival point in time, wherein the number of persons in the vehicle is determined on the basis of the at least one selected image.

### CROSS-REFERENCE TO RELATED APPLICATIONS

This application claims the benefit of and priority to European Patent Application No. 22205863.8, filed on Nov. 7, 2022, the entire contents of which are hereby incorporated by reference.

### BACKGROUND

### Field

Aspects of the present disclosure relate to a computer implemented method for determining a number of persons in a vehicle and a device for determining a number of persons in a travelling vehicle.

### SUMMARY

One aspect provides an improved method and an improved device for determining a number of persons in a vehicle.

Certain improvements are achieved by the independent claims. Certain further improvements are achieved by the dependent claims.

In certain aspects, an example computer implemented method for determining a number of persons in a travelling vehicle is proposed. Multiple images of a recording area are recorded in chronological succession using a camera in this case. The images are stored in a data memory. The recording points in time, at which the images are recorded, may be stored in addition to the images in the data memory. Moreover, an arrival point in time of the travelling vehicle in the recording area is determined with the aid of a sensor. The vehicle moves toward the recording area. For example, the recording area is arranged in the area of a road and comprises at least one section of an image which can be recorded by the camera. The recording area can have, for example, a width of 2 to 10 m in the area of the road viewed in the longitudinal direction of the road. Moreover, the recording area can have a height of 1 to 4 m, in particular perpendicular to a road surface, in the area of the road.

Moreover, a velocity of the vehicle can be determined with the aid of the sensor, which detects, for example, a distance of the vehicle in relation to the sensor. The velocity can be determined, for example, with the aid of a laser signal. Moreover, a change over time of the distance of the vehicle to the sensor can be detected. An arrival time of the vehicle in the recording area can thus be determined on the basis of the velocity and the distance of the vehicle. For this purpose, the relative position of the recording area in relation to the sensor is known and is taken into consideration in the determination of the arrival time of the vehicle in the recording area. The point in time at which the vehicle is completely located in the recording area can be accepted as the arrival time, for example. However, depending on the selected embodiment, other points in time can also be selected as the arrival point in time, such as for example the point in time at which a front section of the vehicle is located in the recording area or a rear section of the vehicle viewed in the travel direction is located in the recording area.

The arrival point in time is used to select at least one image from the data memory which was recorded in a time range around the arrival point in time. The time range can be selected so that at least one image of the data memory is selected in which the vehicle is at least partially, in particular completely, located in the recording area. The number of persons in the vehicle is determined on the basis of the at least one selected image. Various methods, such as for example a visual examination by an operator or an image evaluation method, can be used here to determine the number of persons in the vehicle on the basis of the image and the body parts of the persons shown in the image. For example, an artificial intelligence, in particular a trained neural network, can be used to evaluate the selected image, using which the number of persons in the vehicle is determined.

The described method has the advantage that the camera records the images in chronological succession. The recording of the images is thus decoupled from a precise point in time at which the travelling vehicle moves into the recording area. Due to the recording, which is continuous in particular, of images following one another in chronological succession, the camera does not have to be activated separately for the recording of an image. The recorded images can be selected and analyzed later.

Since the camera is stationary, the recording area is spatially defined. The shorter the recording time of the camera, the more insensitive the recorded image is to natural incident light, which changes over the course of the day. Moreover, an artificial light source and/or a daylight filter can additionally be used in order to further reduce interfering effects of the ambient light. Since the arrival point in time of the vehicle in the recording area is detected with the aid of the sensor, the images or the image can be selected which enable/enables (e.g., the best possible) evaluation with respect to the number of persons in the vehicle. The defined time range and the arrival point in time can be varied in such a manner that at least one image or multiple images, for example two to ten images, were recorded in the time range in which at least a section of the interior of the vehicle is scanned in the image.

In one embodiment, the recording area is artificially illuminated by a light source at the recording points in time at which the camera records the images of the recording area. Depending on the selected embodiment, the recording area can also be illuminated with the aid of the light source over a longer period of time, which comprises at least two successive recording points in time of two successive images. A shorter illumination of the recording area has the advantage that less current is consumed by the light source, the light source has a shorter illumination time and is thus stressed less. Moreover, the persons of the vehicle are blinded less by a shorter illumination time. The lesser blinding effect of the short-term light emission by the light source is advantageous in particular for the driver of the vehicle, since his eyesight is impaired less by the light of the light source.

In a further embodiment, the light source emits electromagnetic radiation having a wavelength between 720 nm and 750 nm. In particular wavelengths between 730 nm and 735 nm have proven to be advantageous in experiments. The proposed wavelength range has the advantage that electromagnetic radiation having this wavelength penetrates with a high proportion into the interior of the vehicle even in vehicles having thermal insulation glazing and thus illuminates the interior well. The contrast of the recorded images is thus increased. Moreover, the exposure time of the camera can be selected to be shorter due to the good illumination of the interior, so that the sharpness of the recorded image is high in particular in the case of rapidly travelling vehicles. The short exposure time of the camera reduces or avoids blurring of a depiction of a person in the image.

In a further embodiment, the camera records images at a recording rate of more than 40 images per second. The higher the recording rate of the images, the greater the probability that images having a high information content of the interior of the vehicle travelling past will be recorded. Therefore, the number of the images in which the interior of the vehicle is visible on the images is also increased in the case of rapidly travelling vehicles by a high recording rate. Experiments have shown that at a recording rate of more than 60 or 75 images per second, in particular of more than 100 images per second, sufficient images for a good recognition of the number of persons in the vehicle are available even in the case of rapidly travelling vehicles at velocities of greater than 100 km/h or greater than 130 km/h.

The exposure time of the camera can be, for example, 50 μs and shorter. The time intervals between the exposures of the individual images can be, for example, in the range between 0.014 to 0.011 seconds.

In a further embodiment, the light source has a radiant power of greater than 1,000,000 lumen, in particular greater than 2,000,000 lumen or more. The emitted light can have the color temperature cool white. The light source can consume at least 8 kW, in particular at least 12 kW or more, of power.

In a further embodiment, the light source is designed to emit the electromagnetic radiation in the form of pulsed radiation. The pulsed radiation can have, for example, an illumination time of less than 70 μs, in particular less than 50 μs, or less than 35 ms. The frequency of the illumination by the light source corresponds, for example, to the image recording frequency of the camera. For example, the light source is controlled by the camera.

The pulsed radiation may be emitted by the light source at the recording points in time of the camera in order to achieve the best possible illumination of the recording area at the recording points in time. Due to the short pulse times or the short illumination time, the persons of the vehicle are hardly or only slightly blinded. The safety of the persons in the vehicle, in particular the driving capability of the driver of the vehicle, is thus hardly impaired or not at all.

In a further embodiment, multiple stored images, in particular two to ten images, in a time range around the arrival point in time are selected from the data memory. The number of persons in the vehicle is determined on the basis of the selected images.

The selected images are examined, for example, as to which of the selected images shows the greatest number of persons in the vehicle. The greatest number of persons of the selected images may be output as the recognized number of persons in the vehicle.

A more precise determination of the number of persons can be achieved by the use of multiple images. Since the selected images were recorded in chronological succession, the selected images show the vehicle from various recording directions. The use of multiple images increases the probability that the actual number of persons located in the vehicle is visible at least on one of the selected images. Moreover, the use of multiple selected images can have the result that individual or multiple selected images having poor image quality do not impair the result of the determined number of persons. Moreover, experiments have shown that two to ten images can be evaluated using a computer program for automatic image evaluation sufficiently rapidly to determine the number of persons in the vehicle promptly. The evaluation for the recognition of the number of persons in the vehicle can take place in less than 1 second.

In one embodiment, the at least one selected image is evaluated with the aid of an artificial intelligence, in particular with the aid of a trained neural network. The artificial intelligence evaluates the at least one selected image as to how many persons are recognizable in the vehicle on the selected image. For this purpose, the artificial intelligence can have been trained beforehand accordingly using a machine learning method. For example, open-source programs such as Python are used for the neural network. The training of the neural network is carried out with the aid of labelled comparison images, in which the number of persons shown in the image is known.

In a further embodiment, multiple selected images are evaluated with the aid of the artificial intelligence as to how many persons are recognizable in the vehicle on the selected images. The greatest number of persons in one of the selected images may be output as the number of persons of the vehicle. The artificial intelligence can also have been trained beforehand using a corresponding machine learning method in this embodiment.

In a further embodiment, multiple second images, such as of a second recording area, are taken in chronological succession with the aid of a second camera. The second images are stored in a data memory, wherein an item of time information about the recording points in time of the second images is also stored in the data memory. The second recording area differs, for example, in the size and/or in an angle at which the second camera is oriented on the vehicle. The recording area and the second recording area can overlap. The second recording area can be selected so that the vehicle is recorded from the front. Moreover, a second arrival point in time of the travelling vehicle in the second recording area is determined with the aid of the sensor or with the aid of a second sensor. At least one second image, which is stored in the data memory, and which was recorded in a time range around the second arrival point in time, is selected on the basis of the second arrival point in time. The time range can comprise a range chronologically earlier and a range chronologically later than the second arrival point in time. Moreover, the time range can also only comprise one range which is chronologically earlier or chronologically later than the second arrival point in time.

A second number of persons in the vehicle is determined on the basis of the at least one selected second image. A number of persons in the vehicle is determined as a function of the determined number of persons in the vehicle on the basis of the first images of the camera and the determined second number of persons in the vehicle on the basis of the second images of the second camera. The first and the second images can be taken into consideration here, for example, in such a manner that the greatest number of the determined persons of the first and/or the second images is determined and output as the number of persons in the vehicle.

Due to the use of the second camera and the second images, on the one hand, a redundancy for the acquisition of the images and a redundancy for the recording area are provided. The second images of the second camera are used analogously and in particular additionally to the first images of the first camera for the determination of the number of persons in the vehicle.

A device for determining a number of persons in a vehicle is proposed. The device comprises a camera, a data memory, a sensor, and at least one computing unit. The camera is designed to take multiple images of a recording area in chronological succession. The images are stored in the data memory. Moreover, items of time information for the images, which specify the recording points in time of the images, are stored in the data memory. The sensor is designed to detect a relative position of the vehicle in relation to the sensor. The computing unit and/or the sensor are designed to compute a velocity of the vehicle. The computing unit is moreover designed to determine an arrival point in time of the vehicle in the recording area as a function of the velocity of the vehicle and a distance of the vehicle from the recording area. The recording point in time defines the point in time at which the travelling vehicle will reach the recording area. The recording area defines an area which is at least partially acquired by the camera upon the recording of an image. The computing unit or the camera are designed to select at least one image from the data memory which was recorded in a time range around the arrival point in time. Depending on the selected embodiment, the camera or the computing unit can also select an image recorded at the arrival point in time. Moreover, the computing unit is designed to determine the number of persons in the vehicle on the basis of the at least one selected image. Image recognition methods, in particular an artificial intelligence, can be used for this purpose. The artificial intelligence can be designed, for example, as a trained neural network.

In a further embodiment, the camera is designed to record the images of the recording area at recording points in time, in particular having equal time intervals between the recording points in time. Moreover, a light source can be provided, wherein the light source is designed to illuminate the recording area at the recording points in time. The light source is designed, for example, to emit electromagnetic radiation at a wavelength between 720 nm and 750 nm, in particular between 730 nm and 735 nm. Depending on the selected embodiment, the light source can also emit electromagnetic radiation at another wavelength, which is also less than 720 nm or also greater than 750 nm.

In a further embodiment, the light source is designed to emit the electromagnetic radiation at a high power, in particular at a light power of at least 1,000,000 lumen, in particular of at least 2,000,000 lumen or more. The light source is designed to emit the electromagnetic radiation using an illumination time of less than 70 μs, in particular of us then 60 μs or less than 30 μs. The illumination time defines the period of time at which the light source emits the electromagnetic radiation at a power of more than 10% of the maximum or the average light power of the light source. Due to the short illumination time of the light source, the light source is capable of emitting the electromagnetic radiation in a pulsed manner and in particular at the recording points in time of the camera.

The shorter the illumination time of the light source, the fewer the negative effects for the persons of the vehicle and in particular for the driver of the vehicle with respect to a blinding effect due to the light source. Moreover, the power consumption is significantly reduced by the pulsed operation of the light source.

In a further embodiment, the camera is designed to record images at a recording rate of more than 40 images per second, in particular of more than 60 images per second, and in some cases of more than 75 images per second, and store them in the data memory. The shorter the exposure time of the camera for an image, the less the interfering influences due to natural or artificial additional illumination, which can change over the course of the day. Furthermore, the probability is increased by a high recording rate that multiple images will be recorded of an interior of the vehicle while the vehicle travels through the recording area. Therefore, more images are available for recognizing the number of persons who are located in the vehicle.

In a further embodiment, the computing unit is designed to execute a program in the form of an artificial intelligence, in particular in the form of a trained neural network. The artificial intelligence is designed to evaluate the at least one selected image as to how many persons are recognizable in the selected image in the vehicle. Moreover, the computing unit is designed to output the recognized number of persons in the image as the number of persons in the vehicle. Rapid and reliable determination of the persons shown in the images, who are located in the vehicle, can be achieved by the use of an artificial intelligence, in particular the use of a trained neural network.

In a further embodiment, the computing unit and/or the camera is designed to select multiple images stored in the data memory in a time range around the arrival point in time. The computing unit is designed, for example, to select two to ten images or more images in the time range around the arrival point in time from the data memory.

Moreover, the artificial intelligence is designed to determine the number of the recognized persons on the basis of the selected images. For example, the artificial intelligence can be designed to determine and output the greatest determined number of persons of the selected images as the number of persons of the vehicle.

In a further embodiment, the computing unit is designed to evaluate images of a second camera, which takes second images of a second recording area, and to determine the number of persons in the vehicle on the basis of the second images. For this purpose, the second images of the second camera can be processed and evaluated in the same manner as the images of the first camera.

### DESCRIPTION OF THE DRAWINGS

The above-described properties, features, and advantages of various aspects described herein and the manner in which they are achieved will become clearer and more comprehensible in conjunction with the following description of the exemplary embodiments, which are explained in more detail in conjunction with the drawings, wherein

FIG. 1 shows a schematic representation of a device for determining a number of persons in a travelling vehicle.

FIG. 2 shows an example of an image of a camera.

FIG. 3 shows a schematic representation of a data memory having multiple images recorded in chronological succession.

FIG. 4 shows a schematic sequence for carrying out the method for determining a number of persons in a travelling vehicle.

### DETAILED DESCRIPTION

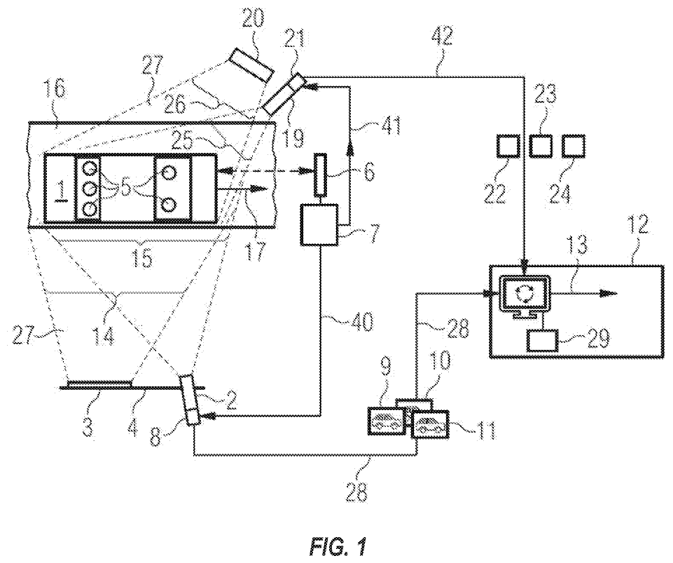

FIG. 1 shows a schematic representation of a device for determining a number of persons in a travelling vehicle. A camera 2 is provided, which is designed to record images of a recording area 15. The recording area 15 is located in the area of a road 16. A vehicle 1 moves in a direction of travel 17 on the road 16. Multiple persons 5 are located in the vehicle 1. A light source 3 can optionally be provided, which emits electromagnetic radiation in an illumination area 14. However, the light source 3 can also be omitted. The illumination area of 14 can comprise at least a section of the recording area 15 or at least the recording area 15 of the camera 2. For example, the illumination area 14 of the light source 3 can comprise the entire recording area 15.

The light source 3 can emit electromagnetic radiation 27 at a wavelength between 720 nm and 750 nm, in particular between 730 nm and 735 nm. Depending on the selected embodiment, the light source can also emit electromagnetic radiation at other wavelengths. Depending on the selected embodiment, the light source can emit electromagnetic radiation having a radiant power of at least 1,000,000 lumen, in particular of at least 2,000,000 lumen or more. Furthermore, the light source can be designed to emit the electromagnetic radiation in a pulsed manner, such as using an illumination time of less than 70 μs, in particular less than 50 μs or less than 35 μs. Moreover, the light source 3 may be designed to emit the electromagnetic radiation in a pulsed manner at recording points in time of the camera. For this purpose, the camera 2 can be connected via a control line 4 to the light source 3 and activate the light source 3 in such a manner that the recording area 15 is illuminated by the light source 3 at the recording points in time of the camera.

The camera 2 may be designed to take multiple images of the recording area 15 in chronological succession. The images may be recorded at equal time intervals by the camera and stored in a data memory 8. The camera 2 may record images continuously, in particular at defined or pre-determinable time intervals at recording points in time, and stores the recorded images in addition with an item of information about the recording points in time of the images in the data memory 8. The time information about the recording point in time can also be established indirectly or only at defined time intervals. For example, a ring data memory is used as the data memory 8, in which the images recorded by the camera are stored in sequence. In this case, the points in time of the recordings can only be established at defined time intervals.

The camera 2 can thus record images in which no vehicle, only a part of the vehicle, or also an entire vehicle is depicted in the recording area 15, i.e., in an image. For example, the camera is designed to record images at a recording rate of more than 40 images per second, of more than 60 or 75 images per second, and store them in the data memory 8. Depending on the selected embodiment, the data memory 8 can also be designed and arranged independently of the camera 2. Moreover, a sensor 6 is provided, which is oriented in the direction of the road 16 and can detect a vehicle 1 and its relative position or its relative distance to the sensor 6. The sensor 6 can detect, for example, with the aid of a laser beam, a relative distance of the vehicle to the sensor 6. The sensor 6 may be arranged in front of the vehicle 1 viewed in the direction of travel 17 of the vehicle.

Furthermore, a computing unit 7 is provided, which is connected via a data line or wirelessly to the sensor 6. The sensor 6 transmits the distances of the vehicle 1 to the sensor 6 at predetermined time intervals and transmits this information to the computing unit 7. Moreover, the sensor 6 can compute the velocity of the vehicle and transmit it to the computing unit 7. The computing unit 7 knows the distance between the recording area 15 or between a center point of the recording area 15 and the sensor 6. In general, the sensor 6 detects the vehicle 1 in a state in which the vehicle 1 is not yet in the recording area 15. The sensor 6 can determine the velocity of the vehicle by a measurement with the aid of a laser signal. Moreover, the computing unit 7 could calculate the velocity of the vehicle 1, at which the vehicle 1 moves in the direction toward the recording area 15, by way of a change over time of the distance of the vehicle in relation to the sensor. Furthermore, the computing unit 7 can compute an arrival point in time of the vehicle in the recording area 15 from the measured distance between the vehicle 1 and the sensor 6 and the known distance between a center point of the recording area 15 and the sensor 6 and the determined velocity of the vehicle.

Since the camera 2 continuously records images of the recording area and stores them in the data memory 8 with an item of time information about the recording point in time, the computing unit 7 can select images from the data memory 8 which were recorded in the range of the arrival point in time of the vehicle. For this purpose, the time information of the camera or the time information of the stored images of the data memory 8 and the time information of the computing unit 7 are synchronized. The computing unit 7 can transmit the arrival point in time of the vehicle in the recording area via a further data line 40 to the camera 2. The further data line 40 can be designed in the form of a line or wirelessly.

Depending on the selected embodiment, the computing unit 7 selects, via the data line 40 or the camera 2 itself, one or more images in a specified time range around the arrival point in time of the vehicle. In the illustrated exemplary embodiment, a first, a second, and a third image 9, 10, 11 are selected and transmitted from the data memory 8 via a data line 28 or wirelessly to a second computing unit 12 or a data memory of the second computing unit 12. Depending on the selected embodiment, the computing unit 7 and the second computing unit 12 can be designed in the form of a single computing unit or in the form of a computer network.

The second computing unit 12 can have a display, which, for example, displays the selected images 9, 10, 11 on the display simultaneously or in succession. In this embodiment, an operator can count the number of persons shown on the images and input it via input means into the second computing unit 12 or a data memory of the second computing unit 12.

In a further embodiment, the second computing unit 12 has programs for image evaluation, using which, persons in an image can be recognized, and a number of persons located in the vehicle can be counted. For example, the computing unit has a program in the form of an artificial intelligence, in particular in the form of a trained neural network. The artificial intelligence is designed in such a manner that the artificial intelligence recognizes persons in a selected image with the aid of image recognition methods and can count the number of persons in the selected image in the vehicle. The artificial intelligence outputs the number of persons recognized in the image in the interior of the vehicle as the number of persons in the vehicle.

The output can take place in the form of a transmission via a data output 13 to a further computing unit. Moreover, the number of persons can be displayed on a display or stored in a further data memory 29. The number of the determined persons of a vehicle can be stored with additional items of information such as a time of day at which the image was recorded, a velocity of the vehicle, a type of the vehicle, a license plate of the vehicle. The license plate of the vehicle can be acquired, for example, using a further camera or using the camera 2. Moreover, the further data of the vehicle can also be transmitted together with the number of persons via the output 13 to a further computing unit.

Depending on the selected embodiment, a second camera 19 having a second data memory 21 can be provided. The second camera 19 is designed to record further images in chronological succession of a second recording area 25 of the road 16. Furthermore, a second light source 20 can be provided which at least partially, in particular completely, illuminates the second recording area 25 in a second illumination area 26. The technical data of the second camera 19 can be equivalent or identical to the technical data of the camera 2. The technical data of the second light source 20 can be identical or equivalent to the technical data of the light source 3. The second camera 19 is designed to record further images 22, 23, 24 of the second recording area 25, such as continuously at specified time intervals, and to store them with items of information about the recording points in time of the further images in the second data memory 21. The computing unit 7 can transmit the second arrival point in time of the vehicle in the second recording area 25 via a second data line 41 to the second camera 19. The second data line 41 can be designed in the form of a line or wirelessly. Moreover, the computing unit 7 and/or the second camera 19 are designed in order to select further images 22, 23, 24 in the area of the second arrival point in time of the vehicle in the second recording area 25 and to transmit them from the second data memory 21 via a third data line 42 to the second computing unit 12 or its further data memory 29. The data lines can be designed in the form of electrical lines or wirelessly.

The computing unit 7 knows the distance between the second recording area 25 or between a center point of the second recording area 25 and the sensor 6. In general, the sensor 6 detects the vehicle 1 in a state in which the vehicle 1 is not yet located in the second recording area 25. The sensor and/or the computing unit 7 compute the velocity of the vehicle 1 at which the vehicle 1 moves in the direction toward the second recording area 25. Furthermore, the computing unit 7 can compute a second arrival point in time of the vehicle in the second recording area 25 from the measured distance between the vehicle 1 and the sensor 6 and the known distance between a center point of the second recording area 25 and the sensor 6 and the determined velocity of the vehicle.

Since the second camera 19 continuously records images of the second recording area 25 and stores them in the second data memory 21 with an item of time information about the recording point in time, the computing unit 7 can select images from the second data memory 21 which were recorded in the range of the second arrival point in time of the vehicle. For this purpose, the time information of the camera or the time information of the stored further images of the second data memory 21 and the time information of the computing unit 7 are known or synchronized.

Depending on the selected embodiment, the computing unit 7 selects one or more further images in a specified time range around the second arrival point in time of the vehicle in the second recording area. In the illustrated exemplary embodiment, a first, a second, and a third further image 22, 23, 24 are selected and transmitted from the second data memory 21 via a further data line or wirelessly to the second computing unit 12 or a further data memory 29 of the second computing unit 12.

The light source 3 may be arranged in such a manner that an emission direction of the light source 3 is oriented at approximately 90° to the direction of travel 17 of the vehicle 1. The emission direction of the light source 3 for the electromagnetic radiation may be oriented at an angle of 90° to the direction of travel 17. The orientation can moreover be oriented perpendicular to a longitudinal extension of the road 16 instead of to the direction of travel 17 of the vehicle 1.

The camera 2 can be oriented, for example, at an angle of 70° to 90° with a central recording axis to the direction of travel 17. The recording axis is perpendicular to the image plane of the camera 2.

The second light source 20 may be arranged in such a manner that an emission direction of the second light source 20 is oriented at an angle less than 45° to the direction of travel 17 of the vehicle 1. For example, the emission direction of the second light source 20 for the electromagnetic radiation is oriented in parallel to the direction of travel 17.

The second camera 19 can be oriented, for example, at an angle of 0° to 45° with a central recording axis to the direction of travel 17. The recording axis is perpendicular to the image plane of the second camera 19. The second camera 19 is arranged to take pictures of the vehicle 1 essentially from the front.

The first and/or the second recording area 15, 25 can be implemented in a simple embodiment by a point on the road. If the vehicle is located having a front of the vehicle body above the point, the vehicle has then reached the recording area.

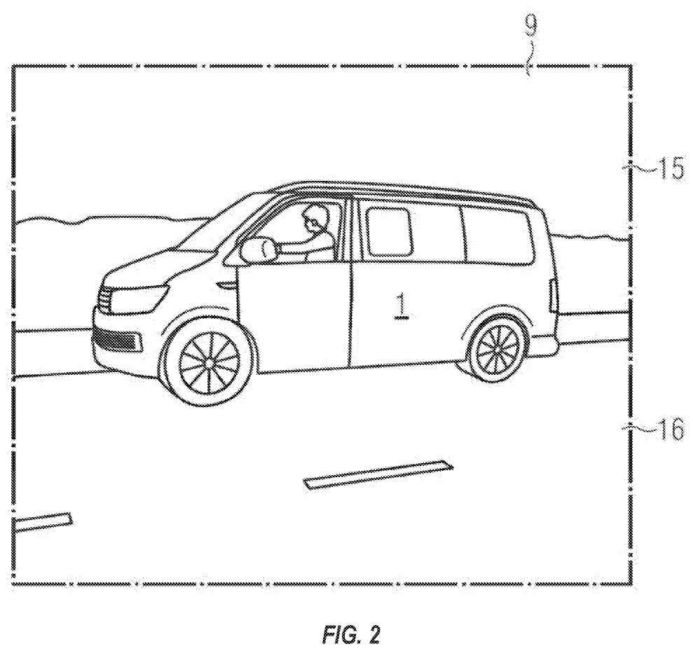

FIG. 2 shows a schematic representation by way of example of an image which was recorded by the camera 2 or by the second camera. The image shows the recording area 15 or the second recording area. The vehicle 1 can be seen in a side view in the image shown.

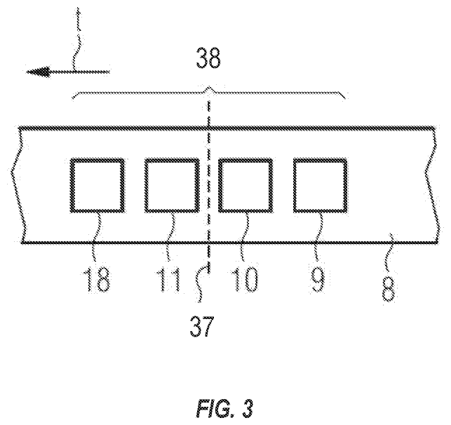

FIG. 3 shows a schematic representation of the data memory 8 having images 9, 10, 11, 18 recorded in chronological succession. More or fewer images can also be recorded and stored in the data memory 8. Moreover, the arrival point in time 37 of the vehicle in the recording area 15 is shown in the form of a dashed line in the chronological representation between the second image 10 and the third image 11. Moreover, the time range 38 in which the stored images 9, 10, 11, 18 for the determination of the number of persons are selected is represented in the form of a curved line symmetrically distributed around the arrival point in time 37. In the illustrated exemplary embodiment, the first, the second, the third, and the fourth image 9, 10, 11, 18 are selected and transmitted to the second computing unit 12.

In an analogous manner, the further images of the second camera can also be stored in the second data memory and provided with an item of information about the recording points in time. The further images are selected in a time range around the second recording point in time and transmitted to the second computing unit 12.

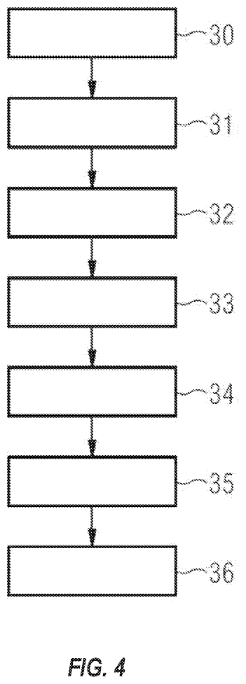

FIG. 4 shows a schematic representation of a method for determining a number of persons in a travelling vehicle. In the described method, two cameras are used. In a simple embodiment, the second camera can also be omitted. At program point 30, the camera 2 and/or the second camera 19 record multiple images of the recording area 15 or the second recording area 25, respectively, in chronological succession. The images of the first camera are stored with an item of information about the recording point in time at program point 31 in a data memory 8. The further images of the second camera are also stored with an item of information about the recording point in time in the second data memory 21 at program point 31. Depending on the selected embodiment, the data memory 8 and the second data memory 21 can be designed as a common data memory, which is moreover designed and arranged independently and separately from the cameras 2, 19.

In parallel to the continuous recordings of the cameras, at program point 32, the distance of the vehicle from the sensor is measured with the aid of the sensor 6 and the velocity of the vehicle is measured with the aid of a laser signal. The distance and the velocity of the vehicle are transmitted from the sensor to the computing unit 7. The computing unit 7 computes, at the following program point 32, on the basis of the velocity of the vehicle, the distance between sensor and vehicle, and the known distance between sensor and recording area, an arrival point in time at which the vehicle will reach the recording area 15. Moreover, the computing unit 7 can compute a second arrival point in time at which the vehicle will reach the second recording area 25. The computing unit 7 knows the distance between the sensor 6 and the recording area 15 and the distance between the sensor 6 and the second recording area 25. Moreover, the computing unit 7 knows the velocity of the vehicle and the distance between the sensor 6 and the vehicle.

The computing unit 7 can thus determine the arrival time of the vehicle in the recording area 15 and/or the second arrival time of the vehicle in the second recording area 25, since the vehicle moves in the direction toward the recording area 15, the second recording area 25, and the sensor 6.

At a following program point 33, the computing unit 7 can transmit the computed arrival time to the camera 2. Depending on the selected embodiment, the camera 2 or the computing unit 7 can access the data memory 8. The camera 2 or the computing unit 7 selects, at a following program point 33, at least one image, in particular multiple images, which were recorded in the range of the arrival time, from the data memory 8. The selected images are transmitted at a following program point 34 to the second computing unit 12. At program point 33, the computing unit 7 can also transmit the computed second arrival time to the second camera 19. Depending on the selected embodiment, the second camera 19 or the computing unit 7 can access the second data memory 21. The second camera 19 or the computing unit 7 selects, at the program point 33, at least one, in particular multiple further images which were recorded in the range of the second arrival time from the second data memory 21 and the selected further images are transmitted at the program point 34 to the second computing unit 12.

At a following program point 35, the second computing unit 12 determines on the basis of the at least one transmitted image, for example, with the aid of image recognition methods, persons who are located on the image in the interior of the vehicle. Moreover, the number of persons which is recognizable in the image is, at program point 36, displayed on a display or output via a data interface as the number of persons who are located in the vehicle.

Depending on the selected embodiment, the recording area 15 and/or the second recording area 25 are illuminated by the light source 3 or the second light source 20 in an illumination area 14 or a second illumination area 26 using electromagnetic radiation.

The first and/or the second camera 2, 19 record the images continuously and in particular at a high recording rate of more than 40 images per second, for example, more than 60 images per second or more than 75 images per second.

The light source 3 and/or the second light source 20 are designed to emit electromagnetic radiation, wherein the electromagnetic radiation in particular has a wavelength between 720 nm and 750 nm, in particular between 730 nm and 735 nm. Moreover, the light source 3 and/or the second light source 20 are designed to emit electromagnetic radiation having a radiant power of at least 1,000,000 lumen, in particular of at least 2,000,000 lumen or more. Moreover, the light source 3 and/or the second light source 20 are designed to emit the electromagnetic radiation as pulsed radiation having an illumination time of less than 70 μs, in particular less than 50 μs or less than 35 μs. The illumination time defines the emission of the electromagnetic radiation with at least 10% or more of the maximum radiant power of the light source.

Depending on the selected embodiment, at program point 33, two to ten images in a time range around the arrival point in time of the vehicle in the recording area are selected from the data memory or around the second arrival point in time in the second recording area are selected from the second data memory. The more images are used, the higher is the probability that the number of persons will be determined precisely. However, at the same time the processing time for the evaluation of the images is higher the greater the number of the images to be evaluated is. Experiments have shown that a number of two to ten images may represent a good compromise between a high accuracy for the recognition of the correct number of persons in the vehicle and a short processing time.

The image recognition at program point 34 is executed, for example, by an artificial intelligence, in particular by a trained neural network. The trained neural network was trained beforehand in such a manner that it can more correctly communicate a number of persons in the vehicle on the basis of images having vehicles.

The accuracy of the correct determination of the persons in the vehicle is also increased upon the use of an artificial intelligence if more images are evaluated. However, the processing time also increases here.

Furthermore, the described method is improved in this manner if further images of the second camera of the second recording area are evaluated in addition to the images of the camera of the recording area. Various strategies can be used here in order to evaluate the images of the two cameras. In a simple case, the number of persons is defined by the maximum recognized number of persons in the vehicle of an image of the camera 2 or a further image of the second camera 19.

Depending on the selected embodiment, the arrival times of the vehicle for the arrival in the recording area 15 can be different from the arrival time in the second recording area 25 of the second camera 19. Moreover, the observation angle and also the sizes of the recording area 15 and the second recording area 25 can differ. Furthermore, the camera 2 and the second camera 19 can record the images using different shutter speeds. Moreover, the light source 3 and the second light source 20 can emit electromagnetic radiation at different wavelengths.

Depending on the selected embodiment, the camera 2 activates the light source 3 for each image in such a manner that at the recording point in time of the image, an illumination of the recording area is present during the recording period of time. For example, the illumination time of the light source 3 is 30 to 70 μs per image. In an analogous manner, the second camera 19 can also activate the second light source 20. The camera 2 and/or the second camera 19 can be designed, for example, as a high-speed camera, for example, from Teledyne Dalsa having an image sensor from Sony having the product designation IMX 250.

The described method can be used, for example, to calculate a toll for the road for the vehicle depending on the number of persons of the vehicle. Moreover, in refinements the application of a safety belt and the use of a mobile wireless device while driving can be monitored. Furthermore, the number of persons of a vehicle can be automatically detected, for example, upon the occurrence of an accident.

The light source 3 and/or the second light source 20 are designed, for example, as high-performance LEDs. Moreover, an identification number of the vehicle can be automatically acquired by the recorded images with the aid of the camera at the same time with the aid of image recognition and stored or output with the information about the number of persons. If an artificial intelligence is used, in particular a trained neural network, the artificial intelligence is designed to recognize the license plate of the vehicle automatically with the aid of an image recognition method.

In a further embodiment, for example, the light source 3 and/or the second light source 20 can emit electromagnetic radiation onto the vehicle frontally, wherein the camera is oriented adjacent to the road at an angle of 10 to 50° to a direction of travel or to a longitudinal direction of the road. For example, the distance between the camera and the vehicle is in a range between 7 and 10 m or in a range between 3 and 8 m. In some cases, the first and/or the second light source are arranged adjacent to the road or with the aid of a mount above the road.

Depending on the selected embodiment, it can be provided that an operator checks the selected and analyzed images once again if the number of the number of persons determined with the aid of the second computing unit 12 is below a specified probability or does not correspond to a previously communicated number of persons. In particular automatic image evaluation methods such as trained neural networks also output a probability for the correctness of the number of persons in the vehicle in addition to the number of the determined persons in the vehicle. The operator can check the actual number once again themselves and correct it in the data memory of the second computing unit 12. The operator can view the images of the first and/or the second camera and assess them together on a display.

Depending on the selected embodiment, the functions of the second computing unit 12 can also be executed by the computing unit 7 and the second computing unit 12 can be omitted.

Although certain aspects were illustrated and described in more detail by an exemplary embodiment, the claimable aspects are not thus restricted by the disclosed examples and other variations can be derived therefrom by a person skilled in the art without leaving the scope of the disclosure.

### LIST OF REFERENCE NUMERALS

1 vehicle
2 camera
3 light source
4 control line
5 person
6 sensor
7 computing unit
8 data memory
9 first image
10 second image
11 third image
12 second computing unit
13 output
14 illumination area
15 recording area
16 road
17 direction of travel
18 fourth image
19 second camera
20 second light source
21 second data memory
22 first further image
23 second further image
24 third further image
25 second recording area
26 second illumination area
27 electromagnetic radiation
28 data line
29 further data memory
37 arrival point in time
38 time range
40 further data line
41 second data line
42 third data line

What is claimed is:

1. A computer implemented method for determining a number of persons in a vehicle, the method comprising:
obtaining multiple images of a recording area in chronological succession from a camera;
storing the multiple images in a data memory;
determining an arrival point in time of the vehicle in the recording area;
selecting at least one image of the multiple images from the data memory based on the arrival point in time, wherein the at least one image was recorded in a time range including the arrival point in time; and
determining the number of persons in the vehicle based on the selected at least one image.

2. The method according to claim 1, further comprising illuminating the recording area with a light source at recording points in time, wherein the camera captures the multiple images of the recording area at the recording points in time.

3. The method according to claim 2, wherein the light source emits electromagnetic radiation at a wavelength between 720 nm and 750 nm.

4. The method according to claim 2, wherein the light source emits electromagnetic radiation at least one of: 1) having a radiant power of at least 1,000,000 lumen; or 2) in a pulsed manner, having an illumination time of less than 70 μs, at the recording points in time.

5. The method according to claim 1, wherein the camera records images at a recording rate of more than 40 images per second.

6. The method according to claim 1, wherein selecting the at least one image comprises selecting a plurality of images of the multiple images from the data memory based on the arrival point in time, wherein the plurality of images were recorded in the time range, and wherein determining the number of persons in the vehicle comprises:
determining a respective candidate number of persons in the vehicle for each of the plurality of images;
determining which of the plurality of images shows a greatest number of persons in the vehicle among the plurality of images based on the determined respective candidate number of persons in the vehicle for each of the plurality of images; and
determining the greatest number of persons as the number of persons in the vehicle.

7. The method according to claim 1, wherein determining the number of persons in the vehicle comprises evaluating the at least one image with an artificial intelligence model to recognize how many persons are in the vehicle in the at least one image.

8. The method according to claim 1, wherein selecting the at least one image comprises selecting a plurality of images of the multiple images from the data memory based on the arrival point in time, wherein the plurality of images were recorded in the time range, and wherein determining the number of persons in the vehicle comprises:
evaluating the plurality of images with an artificial intelligence model to determine a respective candidate number of persons in the vehicle for each of the plurality of images;
determining which of the plurality of images shows a greatest number of persons in the vehicle among the plurality of images based on the determined respective candidate number of persons in the vehicle for each of the plurality of images; and
determining the greatest number of persons as the number of persons in the vehicle.

9. The method according to claim 1, further comprising:
obtaining additional images of a second recording area in chronological succession from a second camera;
storing the additional images in the data memory;
determining a second arrival point in time of the vehicle in the second recording area; and
selecting at least one additional image of the additional images from the data memory based on the second arrival point in time, wherein the at least one additional image was recorded in a second time range including the second arrival point in time, wherein determining the number of persons in the vehicle based on the selected at least one image comprises:
determining a first candidate number of persons in the vehicle based on the selected at least one image;
determining a second candidate number of persons in the vehicle based on the selected at least one additional image; and
determining the number of persons in the vehicle based on a greater of the first candidate number of persons and the second candidate number of persons.

10. A system configured to determine a number of persons in a vehicle, comprising;
a camera configured to capture multiple images of a recording area in chronological succession;
a data memory configured to store the multiple images;
at least one sensor configured to detect a relative position of the vehicle in relation to the at least one sensor; and
at least one computing unit configured to:
compute a velocity of the vehicle based on the relative position;
determine an arrival point in time of the vehicle in the recording area based on the relative position, the computed velocity, and a distance of the vehicle from the recording area; and
determine the number of persons in the vehicle based on at least one image of the multiple images that was captured within a time range including the arrival point in time.

11. The system according to claim 10, wherein the camera is configured to capture the multiple images of the recording area at recording points in time having equal time intervals between the recording points in time.

12. The system according to claim 11, further comprising a light source configured to illuminate the recording area at the recording points in time.

13. The system according to claim 12, wherein the light source is configured to emit electromagnetic radiation at a wavelength between 720 nm and 750 nm.

14. The system according to claim 12, wherein the light source is configured to emit electromagnetic radiation at least one of: 1) having a radiant power of at least 1,000,000 lumen; or 2) in a pulsed manner, having an illumination time of less than 70 μs, at the recording points in time.

15. The system according to claim 10, wherein to determine the number of persons in the vehicle, the at least one computing unit is configured to:
evaluate the at least one image with an artificial intelligence model to determine how many persons are in the at least one image.

16. The system according to claim 10, wherein the at least one image comprises a plurality of images, and wherein to determine the number of persons in the vehicle, the at least one computing unit is configured to:
evaluate the plurality of images with an artificial intelligence model to determine a respective candidate number of persons in the vehicle for each of the plurality of images;
determine which of the plurality of images shows a greatest number of persons in the vehicle among the plurality of images based on the determined respective candidate number of persons in the vehicle for each of the plurality of images; and
determine the greatest number of persons as the number of persons in the vehicle.

17. The system according to claim 10, further comprising a second camera configured to capture additional images of a second recording area in chronological succession, wherein:
the at least one sensor is configured to detect a second relative position of the vehicle in relation to the at least one sensor;
the at least one computing unit is further configured to:
compute a second velocity of the vehicle based on the second relative position; and
determine a second arrival point in time of the vehicle in the second recording area based on the second relative position, the second velocity, and a second distance of the vehicle from the second recording area; and
to determine the number of persons in the vehicle, the at least one computing unit is configured to determine the number of persons in the vehicle based on the at least one image and at least one second image of the additional images that was captured in a second time range including the second arrival point in time.

18. A method for determining a number of persons in a vehicle, the method comprising:
obtaining multiple images of a recording area in chronological succession from a camera;
illuminating the recording area with a light source at recording points in time, wherein the camera captures the multiple images of the recording area at the recording points in time, wherein the light source emits electromagnetic radiation at a wavelength between 720 nm and 750 nm, and wherein the camera records images at a recording rate of more than 40 images per second;
storing the multiple images in a data memory;
determining an arrival point in time of the vehicle in the recording area;
selecting a plurality of images of the multiple images from the data memory based on the arrival point in time, wherein the plurality of images are recorded in a time range including the arrival point in time;
determining a respective candidate number of persons in the vehicle for each of the plurality of images;
determining which of the plurality of images shows a greatest number of persons in the vehicle among the plurality of images based on the determined respective candidate number of persons in the vehicle for each of the plurality of images; and
determining the greatest number of persons as a number of persons in the vehicle.

19. The method according to claim 18, wherein the light source emits electromagnetic radiation at least one of: 1) having a radiant power of at least 1,000,000 lumen; or 2) in a pulsed manner, having an illumination time of less than 70 μs, at the recording points in time.
